(19) United States
(12) Patent Application Publication
(10) Pub. No.: US 2012/0071050 A1
(43) Pub. Date: Mar. 22, 2012

(54) Core material plate

(75) Inventor: Jens Sivert Bak, Ringkobing (DK)

(73) Assignee: JSB Plast v / Jens Sivert Bak

(21) Appl. No.: 12/807,944

(22) Filed: Sep. 17, 2010

(51) Int. Cl. B32B 5/32; B32B 27/06; B32B 38/04

(52) U.S. Cl. 442/1; 156/250; 428/411.1; 428/304.4; 428/318.4

(57) ABSTRACT

A core material plate for a composite structure, such as a rotor blade for a wind turbine (but not limited to) comprises plate portions of at least two core material plate blanks joined together with a binding means. The invention generates a higher standard of accuracy achieving a repeatable better quality. And, further, reducing wastage of the core raw materials using a lot less of core material plates according to embodiments of the core material plate according to the first aspect of the invention. Less wastage is benefiting the environment. All in all, the method is able to give the composite industry a better working environment and large savings on incremental costs, such as, but not limited to, transportation costs, logistics costs, warehouse stock costs and other costs involved in the production chain of manufacturing rotor blades.

The present invention relates in a first aspect to a core material plate for the production cycle of a composite structure, such as to a rotor blade for a wind turbine (but not limited to).

In the wind energy industry core material plates are used in composite structures for manufacture of wings for wind turbines. Such composite structures are also used in boats, planes and other constructions requiring a strong, flexible and light structure.

One prior art method of manufacturing a turbine wing or blade for a wind turbine involves first moulding fibre glass and/or resin into bottom and top half shells of a wing, the shells having a suitable curved structure. Each half shell is enforced by the use of a plurality of core material plates, manufactured from for example balsa wood or a foam material, placed side by side along the length of the entire half shell such as to cover at least a part of the inner surface of each half shell. Then another layer of fibre glass and/or resin is moulded onto an inner surface of the core material structure. Thus, a sandwich structure comprising two layers of for instance fibre glass surrounding a core layer of core material is formed. The layers are firmly attached to each other, liquid glass fibre and/or resin material being drawn into the core material plate material or slits or the like cut into the plates. Each layer of such a structure comprises thickness of the order of perhaps 0.5 to 10 cm.

A similar sandwich structure can be provided to form an internal, e.g. box-shaped, spar, which likewise extends in the length of the half shell. The purpose of the spar is to provide greater strength and stiffness of the wing.

Generally the wind turbine wing manufacturer receives the core material plates in kits, one kit comprising a number of core material plates cut in shapes fitting one complete wing half shell. The individual plates of a kit must have carefully calculated dimensions such as to fit in a previously determined position in the wing structure. The wind turbine wing manufacturer generally provides the necessary details regarding the shape of the core material plates constituting a kit based on calculations regarding distribution of forces along the wing. The plates typically vary in thickness and/or material along the wing length such as to provide the necessary strength in all sections of the wing.

In a prior art method for cutting core material plates, core material plates are normally cut into desired shapes, which are most frequently quadrangular, but may in principle be of any desired shape. The shapes are cut by first, when necessary, making a form or template corresponding to a shape of core material plate requested by a customer. Then the form having the desired shape is placed on top of a single core material plate blank, an operator drawing along the shape of the form. By the use of a cutting device or sawing machine the operator saws or cuts along the lines drawn on the core material plate blank. The core material plate blanks are provided in the form of single plate shaped pieces of a rectangular cross section of perhaps 1×2 m. With the prior art method it is possible to cut up to six identical shapes of core material simultaneously by stacking a corresponding number of core material plate blanks.

This prior art method is widely used throughout for instance the wind energy industry. However, this method presents several disadvantages. First and foremost, a significant core material waste percentage occurs as frequently only one core material plate may be cut from each core material plate blank, the remainder of the plate blank being discarded. Further, the traditional method takes up a large amount of manufacturing time and provides significant risks of lack in accuracy both in drawing and cutting. All in all, the prior art method involves high environmental and economic costs.

The present invention therefore in a first aspect aims at providing a core material plate, which can be manufactured with lower environmental and economic costs.

According to the first aspect of the invention this object is met by the provision of a core material plate for a composite structure, such as a rotor blade for a wind turbine, characterized by comprising plate portions of at least two core material plate blanks joined together with a binding means.

The core material plate according to the first aspect of the invention can be manufactured with a significantly smaller waste of core material since it can be manufactured by joining individual core material plate blanks together in a continuous sheet. This provides for the possibility of arranging and cutting a plurality of sections of desired shapes in a way leaving very little or no space at all between sections along the length of the continuous core material sheet, thus minimizing the material wasted between the sections. In this way a saving in core material used of up to 20% or more compared to the described prior art method may be obtained.

In a particularly preferred embodiment of the first aspect of the invention said core material plate blanks are manufactured from balsa wood. Said binding means preferably comprises a web structure, such as a continuous or infinite net. Said web structure is preferably attached to an upper or lower surface of said core material sheet. If said balsa wood further has been cut into smaller pieces, e.g. of sizes of about 1-10×1-10 cm, held together by said web structure, a very flexible core material plate is provided. Furthermore, glass fibre material will more readily be able to be drawn in between the smaller pieces, providing for a stronger, more coherent composite structure. This embodiment thus provides for a particularly high flexibility and adhesion in construction and moulding of a composite sandwich structure.

Further advantageous embodiments are provided in the dependent claims.

In a second aspect the invention provides a method for producing core material plates for a composite structure, such as a rotor blade for a wind turbine, comprising the steps of:
providing a plurality of core material plate blanks,
joining said plurality of core material plate blanks together with a binding means to form a continuous core material sheet, and
cutting said continuous core material sheet into core material plates of desired shapes.

Advantages of the first aspect of the invention as described above also apply to the second aspect of the invention.

Advantageous embodiments of the second aspect of the invention are provided in the dependent claims. These embodiments provide advantages such as saving significant amounts of manufacturing time and considerably improving accuracy, as the amount of manual work related to the method is minimized.

Furthermore, the embodiments provide advantages such as the possibility of, through programming of a cutting device, to quickly and easily alter cutting parameters to comply with possible changes in customer demands, thus further reducing manufacturing time.

In a third aspect the present invention provides a continuous core material sheet to be cut into core material plates for a composite structure, such as a rotor blade for a wind turbine, characterized by comprising a plurality of core material plate blanks joined together in continuation of each other with a binding means such as to form two parallel sides.

Such a continuous core material sheet may, for instance by use of the method according to the second aspect of the invention, be cut into core material plates according to the first aspect of the invention of desired shapes with low waste material percentages for reasons explained above.

The invention will now be described in further detail based on a non-limiting exemplary embodiment, and with reference to the schematic drawings. In the drawings,

### BRIEF DESCRIPTION OF THE DRAWINGS

FIG. 1 shows a shell of a wind turbine rotor blade.

FIG. 2 shows an angle cutting of the rotor blade shell from FIG. 1.

FIG. 3 shows a drawing up of the core material plate of scum or foam with reference to the first aspect of the invention.

FIG. 4 shows a construction of the core material plate of balsa wood with reference to the first aspect of the invention.

FIG. 5 shows how a core material plate of scum shall be cut.

FIG. 6 shows how a core material plate of balsa wood shall be cut.

FIG. 7 shows the cutting method of the core material scum plate done by a conventional technique as known today.

FIG. 8 shows the joining of the core material plate of scum creating the infinite core material sheet with parallel sides as per aspect 3 in the invention.

FIG. 9 shows the amount of core material saved, when one saws the infinite core material sheet made from scum, as per production method shown in FIG. 8.

FIG. 10 shows the cutting method of the core material balsa wood p late d one by a conventional technique as known today.

FIG. 11 shows unification of the core material plate made from balsa wood to the infinite sheet with parallel sides as per aspect 3 in the invention.

FIG. 12 shows the amount of core material saved by sawing the infinite sheet of inner material made from balsa wood, which is manufactured and shown in FIG. 11.

FIG. 13 shows one method of assembly the core material plate made from scum composites.

FIG. 14 shows the method of assembling the core material plate of balsa wood.

FIG. 15 shows one method of cutting the core material plate.

FIG. 16 shows a conveyor device which can transport the core material plate towards the cutting device as per FIG. 15.

### DETAILED DESCRIPTION OF THE PREFERRED EMBODIMENTS

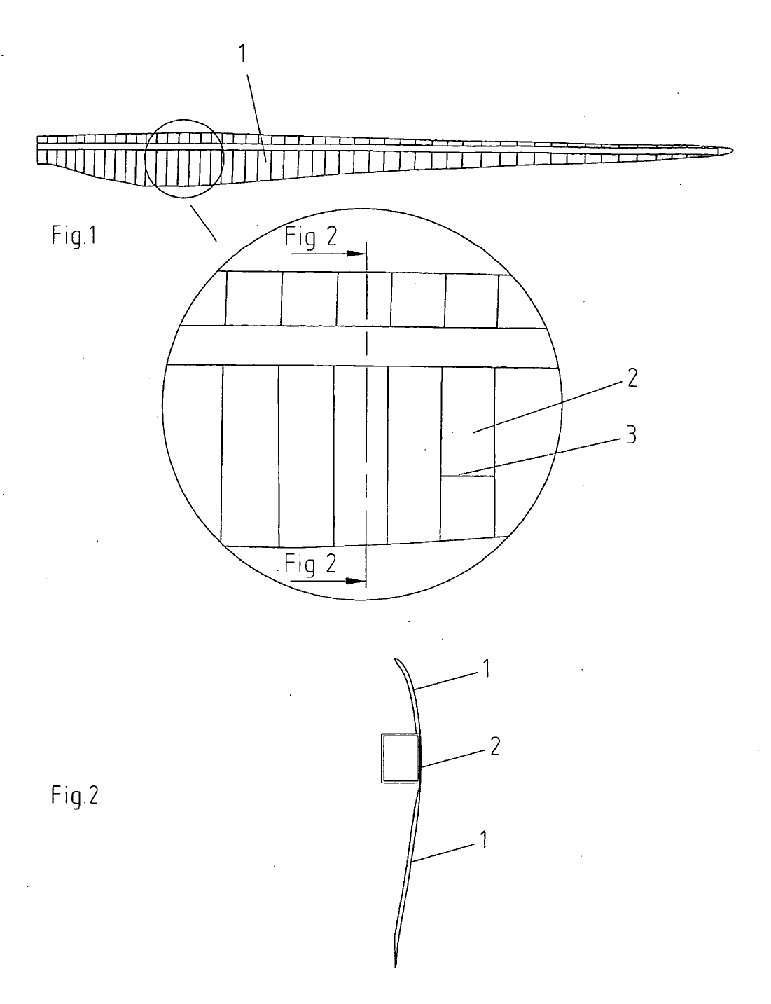

FIG. 1 shows a shell of a wind turbine rotor blade, which has in its contents one kit of the sheet (1) of the inner material produced after the first aspect of the invention. Sheet (2) shows, how the sheet can be joint of at least two sheets. (3) Shows the binding method, which joins minimum two sheets into one sheet.

FIG. 2 shows an angle cutting of the rotor blade shell from FIG. 1. Here one can see how the core material is placed. (2) Is a supporting beam, which is placed inside the shell of the rotor blade.

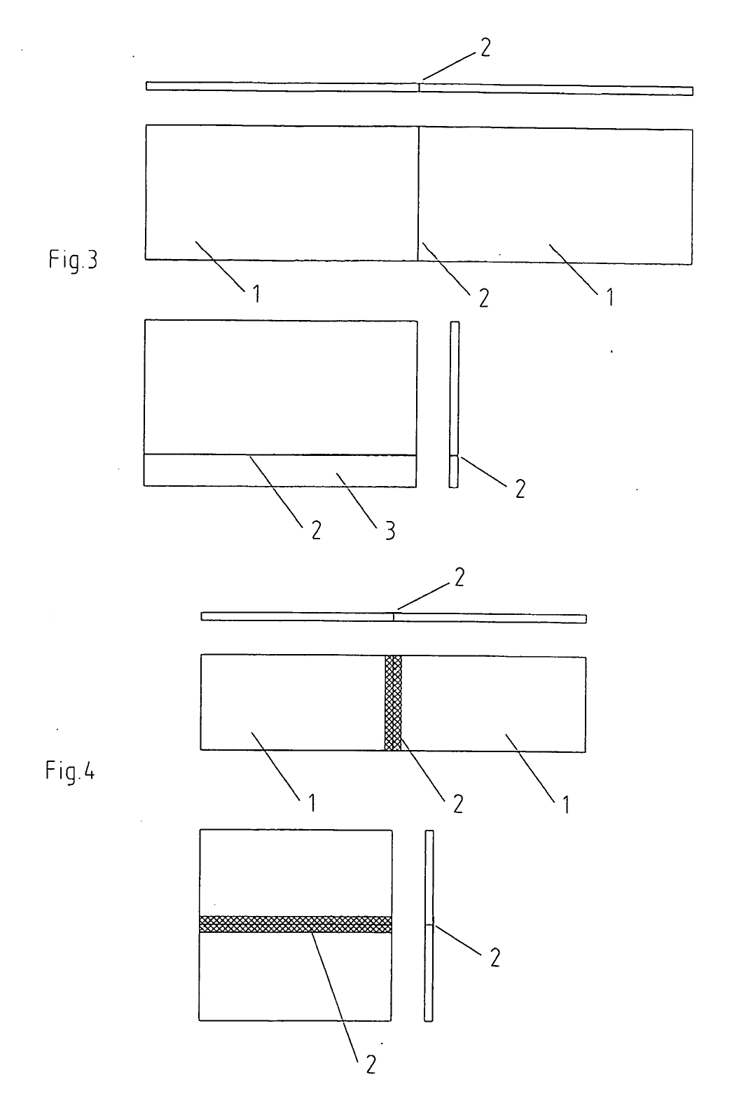

FIG. 3 shows a drawing up of the core material plate of scum with reference to the first aspect of the invention. The new plate then consist of two scum-plates (1), which are assembled with the joining method (2), the new plate can both be assembled of full size plates (1) or with addition of smaller plates (3).

FIG. 4 shows a construction of the core material plate of balsa wood with reference to the first aspect of the invention. The new core material plate, consist of two balsa wood plates (1), which are joined by the joining method (2). The new core material plate can be joined by additional balsa wood plates, either lengthwise and or in all directions.

FIG. 5 shows how a core material plate of scum shall be cut. (3) Straight cutting lines. (2) Is the joining means. (1) Is the plate, which is formed from a scum plate. (4) Is the plate, which cut out of a scum plate, joint together with minimum two scum plates, as per the first aspect of the invention.

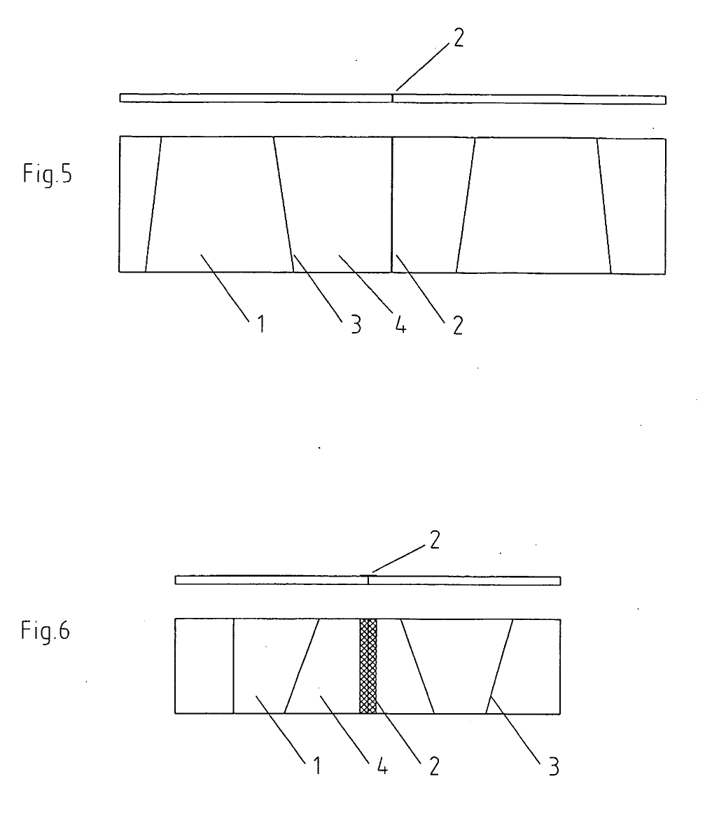

FIG. 6 shows how a core material plate of balsa wood shall be cut. (3) Straight cutting lines. (2) Is the joining means. (1) The plate, which is formed from a balsa wood plate. (4) Is the plate, which cut out of a balsa wood plate, joint together with minimum two balsa wood plates, as per the first aspect of the invention.

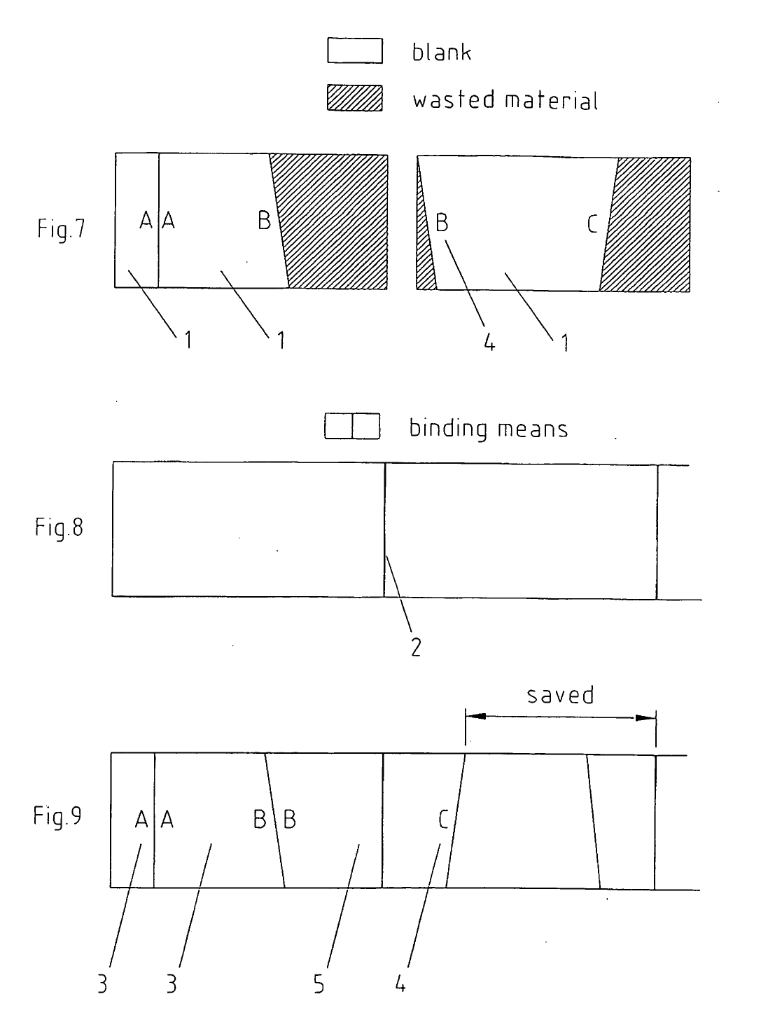

FIG. 7 shows the cutting method of the core material scum plate done by the conventional technique as know today. Every core material plate for a kit of plates can only be cut from one single plate. (1) Here different plates for one kit (4) shows template marking of the plate.

FIG. 8 shows the joining of the core material plate of scum creating the infinite core material sheet with parallel sides as per aspect 3 in the invention using the joining method.

FIG. 9 shows the amount of core material saved, when one saws the infinite core material sheet made from scum, as per production method shown in FIG. 8 (3) is the plate, which is cut out of the scum plate (5) is the plate, which is cut out of the scum plate, then joint together with at least two scum plates from the infinite sheet with parallel sides, as per third aspect of the invention.

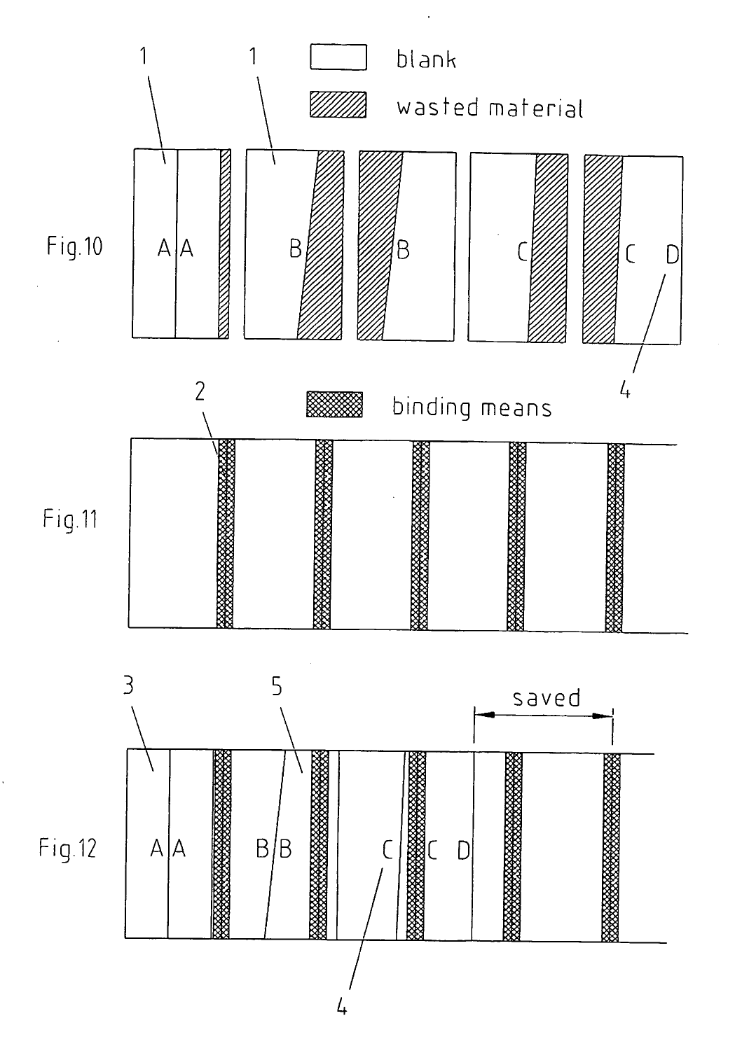

FIG. 10 shows the cutting method of the core material balsa wood plate done by the conventional technique as know today. Every core material plate for a kit of plates can only be cut from one single plate. (1) Here different plates for one kit (4) shows template marking of the plate.

FIG. 11 shows unification of the core material plate made from balsa wood to the infinite sheet with parallel sides as per aspect 3 in the invention by using the binding method.

FIG. 12 shows the amount of core material saved by sawing the infinite sheet of inner material made from balsa wood, which is manufactured and shown in FIG. 11 (3) is the plate, which is cut out of the balsa wood plate (5) is the plate, which is cut out of the balsa wood plate, then joint together with at least two balsa wood plates from the infinite sheet with parallel sides, as per third aspect of the invention.

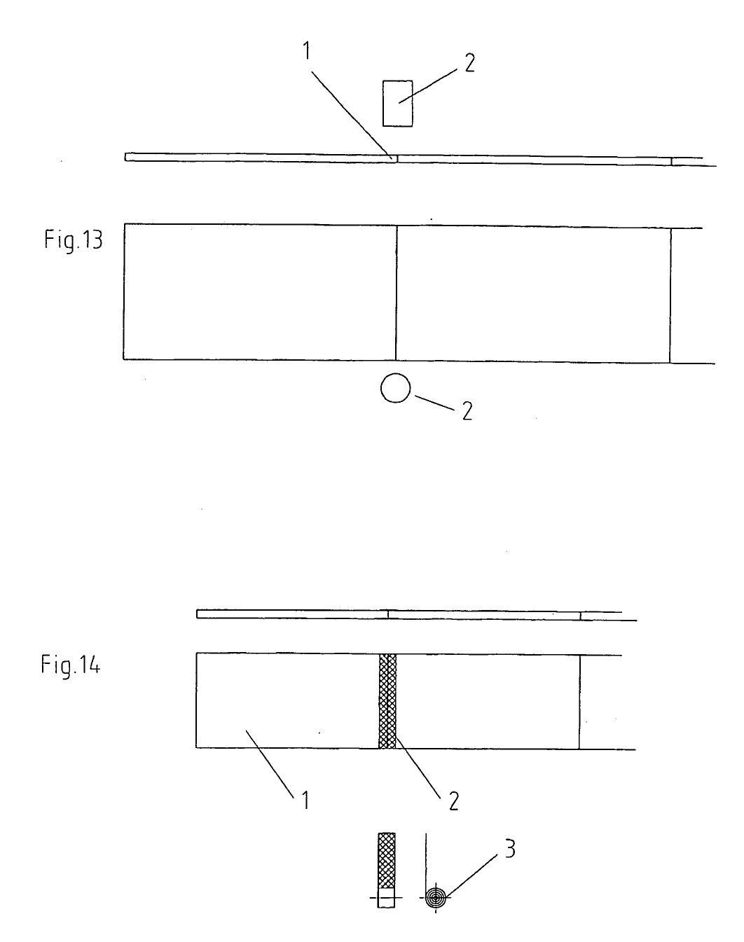

FIG. 13 shows one method of assembly the core material plate made from scum composites. (1) And the binding method is, for example, a thermosetting adhesive such as a hot melt adhesive, together with a hot tool (2) to activate the thermosetting adhesive binding method.

FIG. 14 shows the method of assembling the core material plate of balsa wood. (1) The binding method (2) comprises a web structure, such as a continuous or infinite net, which is rolled off from a roll of a web structure (3) The binding method (2) is mounted on the underside of the inner material balsa wood plate.

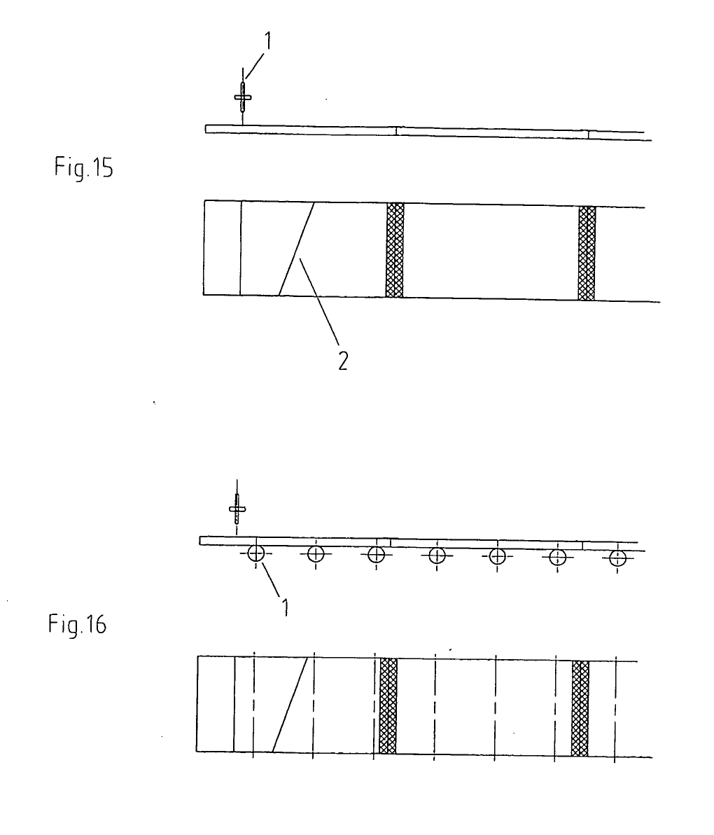

FIG. 15 shows one method of cutting the core material plate. (2) The cutting line. The sawing can occur with a cutting device. The cutting device can be programmed to achieve various settings.

FIG. 16 shows a conveyor device (1) which can transport the core material plate towards the cutting device as per FIG. 15. The conveyor device can also be programmed to achieve the best results.

1. A core material plate for a composite structure, such as but not limited to a rotor blade for a wind turbine, characterized by comprising plate portions of at least two core material plate blanks joined together with a binding means.

2. A core material plate according to claim 1, wherein said core material plate blanks are manufactured from a foam material such as PVC-foam.

3. A core material plate according to claim 2, wherein said binding means comprises an adhesive, preferably a thermosetting adhesive such as a hot melt adhesive.

4. A core material plate according to claim 2, wherein said core material plate blanks are manufactured from balsa wood.

5. A core material plate according to claim 4, wherein said binding means comprises a web structure, such as a continuous or infinite net.

6. A core material plate according to claim 5, wherein said web structure is attached to an upper or lower surface of said core material sheet.

7. A core material plate according to claim 5, wherein said balsa wood has been cut into smaller pieces, e.g. of sizes of about 1-10×1-10 cm, held together by said web structure.

8. A core material plate according to claim 1, wherein it forms part of a composite structure, such as, but not limited to a rotor blade of a wind turbine.

9. A core material plate portion according to claim 1, wherein it forms part of a kit of parts comprising a plurality of core material plates according to claim 1.

10. A method for producing core material plate portions for a composite structure, such as, but not limited to a rotor blade for a wind turbine, comprising the steps of:
providing a plurality of core material plate blanks,
joining said plurality of core material plate blanks together with a binding means to form a continuous core material sheet, and
cutting said continuous core material sheet into core material plates of desired shapes.

11. A method according to claim 10, wherein said binding means comprises a thermosetting adhesive, and wherein said method comprises the further step of providing a heating device for activating said thermosetting adhesive.

12. A method according to claim 10, wherein said binding means comprises a web structure, such as a continuous or infinite net, which is rolled off from a roll of web structure.

13. A method according to claim 10, further comprising the step of providing a cutting device for cutting said continuous core material sheet.

14. A method according to claim 10, further comprising the step of transporting said continuous core material sheet to said cutting device, e.g. by means of a conveyor device such as a conveyor belt.

15. A method according to claim 10, further comprising the step of providing a cutting device such as a sawing device, such as a CNL-saw or a PLC-saw, of a sawing machine for cutting said continuous core material sheet.

16. A method according to claim 10, further comprising the step of providing a programmable control unit connected to said cutting device such as to enable said cutting device to cut in a predetermined pattern.

17. A method according to claim 10, wherein said core material plate blanks are rectangular plates joined together along edges to form a continuous core material sheet with parallel sides.

18. A method according to claim 10, wherein said produced core material plates are according to claim 1.

19. A continuous core material sheet to be cut into core material plate portions for a composite structure, such as, but not limited to a rotor blade for a wind turbine, characterized by comprising a plurality of core material plate blanks joined together in continuation of each other with a binding means such as to form two parallel sides.
